(19) United States
(12) Patent Application Publication
(10) Pub. No.: US 2020/0256695 A1
(43) Pub. Date: Aug. 13, 2020

(54) SYSTEMS AND METHODS FOR DRIVER ASSISTANCE

(71) Applicants: TOYOTA MOTOR EUROPE, Brussels (BE); TOYOTA JIDOSHA KABUSHIKI KAISHA, Toyota-shi, Aichi-ken (JP)

(72) Inventors: Paul GIROND, Brussels (BE); Remi DELEFOSSE, Brussels (BE); Christophe GILLET, Brussels (BE); Naoki NISHIMURA, Toyota-shi (JP); Yoshiya IWAKI, Toyota-shi (JP)

(73) Assignees: TOYOTA MOTOR EUROPE, Brussels (BE); TOYOTA JIDOSHA KABUSHIKI KAISHA, Toyota-shi, Aichi-ken (JP)

(21) Appl. No.: 16/651,705

(22) PCT Filed: Sep. 29, 2017
(86) PCT No.: PCT/EP2017/074826

§ 371 Date: Mar. 27, 2020

(51) Int. Cl. G01C 21/36; G06K 9/00

(52) U.S. Cl. CPC G01C 21/3647; G06K 9/00818; G01C 21/3697

(57) ABSTRACT

A driver assistance system for a vehicle, including optical recognition means configured to obtain data regarding a regulation indicator in proximity to the vehicle, location providing means configured to provide location information indicating a location of the vehicle relative to one or more next links in proximity to the location and to provide feature information related to the one or more next links, and processing means. The processing means are configured to determine whether the data comprises at least one prohibited entry indication, determine a probable next link of the vehicle based on a determined path and/or an anticipated path of the vehicle, and cause display of no-entry information to an operator of the vehicle based on the determination of the at least one prohibited entry indication, the probable next link, and the feature information.

### FIELD OF THE DISCLOSURE

The present disclosure is related to systems and methods for road sign display augmentation, and more particularly, to assist a driver in correctly choosing a road having a permitted entry in the direction of forward travel of the vehicle.

### BACKGROUND OF THE DISCLOSURE

Various systems exist for providing assistance to drivers of motor vehicles. For example, one such area of assistance relates to automated road sign recognition and display.

Road sign recognition may be accomplished by using suitable devices (e.g., optical devices such as a camera) for perceiving or detecting the surroundings of a motor vehicle. Systems are available commercially, for example, both from automobile manufacturers, and from manufacturers of portable navigation devices (PNDs). The PND systems are based on GPS signals and map data for supplying the driver with information relating to road signs.

Some existing systems implement a camera device for improving recognition accuracy and robustness. The manufacturers of vehicles use front-mounted camera devices and means for combining signals with data relating to the driving state of the vehicle. A further option is means for combining signals with navigation devices.

In such systems certain issues exist such as, for example, how long to maintain display of a particular regulation value to the driver (i.e., how long is such a value relevant), what to do when multiple indicators are recognized in succession, and how should a vehicle change in direction or crossing of an intersection affect display of a regulation value. In addition, when a large number of indicators exist in a small area, for example, in a roundabout (i.e., a traffic circle), a system and/or the driver may be unable to discern which sign is applicable to a chosen route, which may be particularly important when the indicator is a one-way or no-entry type sign prohibiting exiting of a vehicle on to the indicated route.

US 2016/0137127 discloses a sign information display system or method, where if a road sign is recognized by a sign recognition device, a display control device determines whether or not it will cause a sign information display device to display first sign information, which is information concerning the road sign, on the basis of a driving state of a front vehicle driving in front of the vehicle.

### SUMMARY OF THE DISCLOSURE

The present inventors have recognized that certain signs, such as, for example, one-way or no-entry signs in a roundabout may be present in such a high number at some road sections, that an imaging system and/or a driver may become confused as to which is the correct path. Therefore, the present configurations are directed to solving this problem.

According to embodiments of the present disclosure, a driver assistance system for a vehicle is provided. The system includes optical recognition means configured to obtain data regarding a regulation indicator in proximity to the vehicle, location providing means configured to provide location information indicating a location of the vehicle relative to one or more next links in proximity to the location and to provide feature information related to the one or more next links, and processing means. The processing means are configured to determine whether the data comprises at least one prohibited entry indication, determine a probable next link of the vehicle based on a determined path and/or an anticipated path of the vehicle, and cause display of no-entry information to an operator of the vehicle based on the determination of the at least one prohibited entry indication, the probable next link, and the feature information.

The feature information may include a directional indicator and/or a no-entry indicator for each next link within a predetermined distance of the location.

When the data is determined to comprise at least one prohibited entry indication, the processor may be configured to determine whether the feature information includes a corresponding no-entry link and, if the feature information includes a corresponding no-entry link, determine if the no-entry link corresponds to the probable next link for determining whether to cause display of no-entry information to the operator.

The determined path and/or anticipated path may be provided based on a preprogrammed destination in the location providing means.

The processing means may be further configured to control the vehicle to prevent the vehicle from exiting onto a no-entry next link.

According to embodiments of the present disclosure, a vehicle comprising the driver assistance system according to the above may be provided.

According to still further embodiments of the present disclosure, a method for assisting an operator of a vehicle is provided. The method includes obtaining data regarding a regulation indicator in proximity to the vehicle, determining, by a processor, whether the data comprises at least one prohibited entry indication, obtaining location information indicating a location of the vehicle relative to one or more next links in proximity to the location, receiving feature information related to the one or more next links, determining, by a processor, a probable next link of the vehicle based on a determined path and/or an anticipated path of the vehicle, and causing display of no-entry information to an operator of the vehicle based on the determination of the at least one prohibited entry indication, the probable next link, and the feature information.

The feature information may include a directional indicator and/or a no-entry indicator for each next link within a predetermined distance of the location.

When the data is determined to comprise at least one prohibited entry indication, a determination as to whether the feature information includes a corresponding no-entry link may be performed and, if the feature information includes a corresponding no-entry link, determine if the no-entry link corresponds to the probable next link for determining whether to cause display of no-entry information to the operator.

The determined path and/or anticipated path may be provided based on a preprogrammed destination in the location providing means.

The processing means may be further configured to control the vehicle to prevent the vehicle from exiting onto a prohibited next link.

It is intended that combinations of the above-described elements and those within the specification may be made, except where otherwise contradictory.

It is to be understood that both the foregoing general description and the following detailed description are exemplary and explanatory only and are not restrictive of the disclosure, as claimed.

The accompanying drawings, which are incorporated in and constitute a part of this specification, illustrate embodiments of the disclosure and together with the description, serve to explain the principles thereof.

### BRIEF DESCRIPTION OF THE DRAWINGS

FIG. 1 shows an exemplary driver assistance system according to embodiments of the present disclosure;

FIG. 2 shows a vehicle on an exemplary road segment having a regulation indicator and conditional information;

FIG. 3 is a schematic representation of a vehicle travelling around a current link traffic circle with a number of next link exits positioned around the circle;

FIG. 4 is a flowchart highlighting an exemplary method according to embodiments of the disclosure; and

FIG. 5 is an illustration to aid in the comprehension of current and next links.

### DESCRIPTION OF THE EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

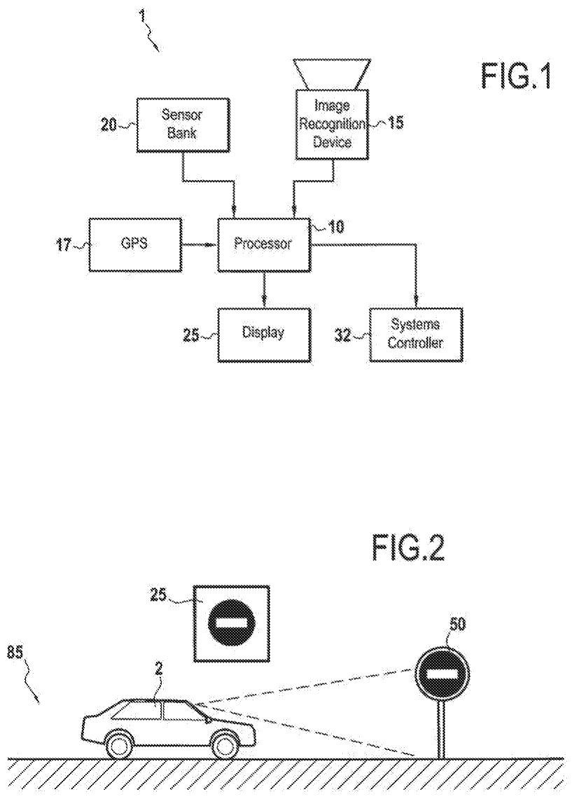

FIG. 1 shows an exemplary driver assistance system 1 according to embodiments of the present disclosure. The driver assistance system 1 may include processing means, such as an electronic control unit (ECU) 10, image obtaining means 15 such as a camera, one or more sensors 20, systems controller 32, and a display 25 among others.

A global positioning system (GPS) 17, corresponding to a location providing means, is also provided for providing map data (e.g., location information such as coordinates) regarding location of the vehicle and feature information regarding features (e.g., regulation indicators, current link information, next link information, one way signs, no entry signs, etc.) in proximity to the vehicle.

GPS 17 may also be configured to receive information from an operator and/or passenger of the vehicle regarding an intended destination in vehicle 2, and to prepare one or more navigation routes to arrive at the destination specified, among others. Information regarding a selected navigation route may subsequently be provided to ECU 10, for use in certain determinations, as will be described in greater detail below.

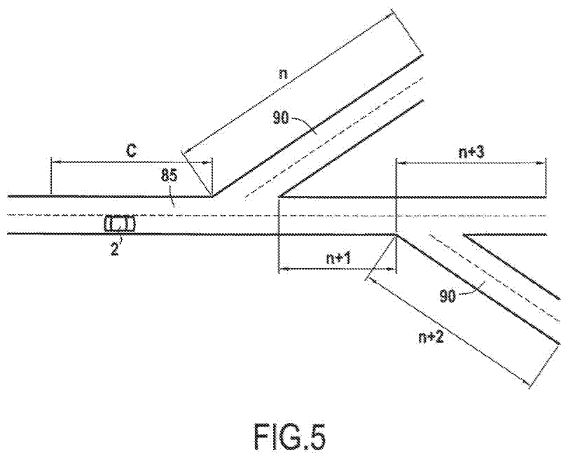

FIG. 5 is an illustration to aid in the comprehension of current links 85 and next links 90. Map data may be broken into portions of a Current Link C, 85 (e.g., the portion of road, for example a length of 500 m, upon which vehicle 2 is currently traveling) and Next Links n . . . n+i, 90 (e.g., the portion or portions of road over which the vehicle could be travelling over a forthcoming distance, i.e., any possible intersection/road segment outside of the exemplary 500 m Current Link information). The length of each link may be predetermined based, for example, the GPS software used, internal logic of vehicle 2, etc. Information associated with these links may include, for example, road class (e.g., controlled access highway, rural route, etc.), exit ramps, road works, traffic signals, directional indicators, etc.

Image obtaining means 15, corresponding to an optical recognition means, may include, for example, one or more cameras and/or other suitable devices configured to obtain optical data from an area surrounding a vehicle (e.g., in front of a forward moving vehicle). Image obtaining means 15 may be configured to process the data obtained from the surroundings of the vehicle to determine the existence of regulation indicators 50 (e.g., road signs such as a one way sign, and/or no entry sign, among others). Such image obtaining means 15 are known in the art, and one of skill in the art will understand that any such image obtaining means 15 may be implemented in the present system without departing from the scope of the present disclosure.

Image obtaining means 15 may be located on a vehicle 2 so as to provide an adequate field of view 4 of the surroundings of the vehicle 2 (e.g. a front and side view spanning approximately 180 degrees). For example, one or more image obtaining means 15 may be located behind the windshield, on a front bumper, a side view mirror, rearview mirror, and/or other suitable mounting location on the vehicle 2 so as to provide a field of view 4 of approaching regulation indicators 50 near the vehicle, including those for indicating no entry and/or one way. According to some embodiments it may be desirable to minimize visibility of image obtaining means 15 for aesthetic reasons, and one of skill in the art will understand that finding a mounting location suitable to achieve this goal while also providing adequate field of view surrounding the vehicle 2 to be a reasonable consideration.

The term “adequate” when referring to field of view as used herein shall mean a field of view providing image obtaining means 15 with the ability to identify regulation indicators 50 present on the road surrounding the moving vehicle and to display information related to said regulation indicators to a driver of the vehicle on display 25 with a success rate for identification of at least 95 percent.

Image obtaining means 15 may be configured to provide data regarding surroundings of a vehicle 2, including regulation indicators 50 to ECU 10. Such data may include, for example, a direction of travel indicator and/or a no-entry indicator, among others.

Image obtaining means 15 may provide such data to ECU 10 via a wired connection, a wireless connection, or other suitable method for transferring data to ECU 10. For example, image obtaining means 15 may include wireless communication means (e.g. IEEE 802.11 compliant Wi-Fi hardware) for transmitting data to ECU 10 and/or other devices that may use the data from image obtaining means 15. Alternatively or in addition, for example for safety purposes, a wired connection may be provided. Such a wired connection may be provided, for example, to provide failsafe in a case where a wireless connection should cease to function.

When obtaining data related to a regulation indicator, image obtaining means 15 may be configured to assign a time indicator (e.g., a timestamp) and/or position indicator (e.g., coordinate information) to the data. Alternatively, ECU 10 may be configured to assign a time indicator to the data upon receipt from image obtaining means 15. By assigning a time indicator to data obtaining by image obtaining means 15, an age of the data (i.e., time elapsed since a regulation indicator was identified by image obtaining means 15) may be tracked by ECU 10, among others.

Map data may be broken into portions of a Current Link (e.g., the portion of road, for example a traffic circle, upon which vehicle 2 is currently traveling) and Next Links (e.g., the exits available on the current link traffic circle). The length of each link may be predetermined based, for example, the GPS software used, internal logic of vehicle 2, etc., and/or, for example, by a change in road network (e.g. crossing) and/or in road attribute (e.g. speed limit, curvature, etc.)

One or more sensors 20 may be configured to transmit state information related to a state of the vehicle to ECU 10. For example, a state of the vehicle may include a speed at which the vehicle is traveling, a direction in which the vehicle is traveling, a change of direction which the vehicle is undergoing and/or has undergone, a position of the steering wheel, a distance which the vehicle has traveled, etc.

Therefore, one or more sensors 20 may include, for example, a steering wheel position sensor, a vehicle speed sensor, a yaw rate sensor, among others. Such sensors, similarly to image obtaining means 15, may be configured to provide such state information wirelessly and/or by wire to ECU 10, and may further include duration information. Duration information associated with the state information may be tracked by ECU 10.

ECU 10 may include any suitable device configured to manipulate data, perform calculations, execute code for decision making, causing display of information to an operator of vehicle 2, and/or cause control of systems controller 32 to take action on one or more systems (e.g., steering, braking, etc.) of vehicle 2, in order to carry out embodiments of the present disclosure. For example ECU 10 may include various analog and/or digital circuits, and may include integrated circuits such as RISC processors, i386 processors, ASIC processors, etc. Typically, on-board computers in modern vehicles include such processors, and one of skill will understand that the present ECU 10 may be comprised by such an on-board computer, or may be separately provided. One of skill in the art will also understand that the exemplary circuits and processors described herein are not intended to be limiting, and that any suitable device may be implemented.

ECU 10 may be linked to one or more databases and/or other memory (e.g., RAM, ROM, etc.) associated with vehicle 2 so as to enable storage of vehicle related data as well as values that may be utilized during processing of vehicle functions (e.g., threshold values), such as regulation indicator validation. One of skill in the art will recognize that information discussed herein with regard to any such databases and/or memory is not intended to be limiting.

ECU 10 may be configured to receive data from image obtaining means 15 and providing functionality associated with the present disclosure. For example ECU 10 may receive data regarding regulation indicators from image obtaining means 15 and one or more sensors simultaneously (e.g., streaming data). Such data may include, for example, a direction indication for a travel direction on a road, and/or no-entry information.

ECU 10 may further be configured to receive data from GPS 17, the data including location information and map information related to features in proximity to the location of the vehicle 2. Location information may include, for example, global coordinates enabling fixing/determining of a position of vehicle 2 on a map to within a desired radius, e.g., 2 m.

Features included in map information may comprise, for example, roundabouts (i.e., traffic circles), exit roads from roundabouts, conditional indicators (e.g., hours of activation, prohibited hours, etc.), topography, etc. One of skill will recognize that more or fewer features may be present in the map information as desired, the level of detail being dependent upon, for example, map information provider, among others. One of skill will further recognize that GPS 17 may form part of ECU 10, may be separate from ECU 10, or any level of combination between GPS 17 and ECU 10 may be implemented without departing from the scope of the present disclosure.

ECU 10 may be linked to one or more interfaces, e.g. network interfaces, which may be configured to receive wirelessly and/or by wire the data and information provided by image obtaining means 15, GPS 17, sensors 20, among others. Further, while the GPS 17 is described as present on vehicle 2, one of skill will understand that certain map data including features of the current and next links, may be stored remotely and transmitted to GPS 17 and/or ECU 10, for example, via 4G, such that up to date information is available.

According to some embodiments, vehicle 2 may include one or more system controllers 32, which may be configured to receive information and/or commands from ECU 10, and to execute those commands to control various vehicle systems (e.g., steering, braking, accelerator, etc.). Such devices may be configured to actively manipulate control systems 32 of vehicle 2, for example, to operate a steering system, a braking system, an acceleration system, etc.

Such devices may include one or more servo motors, actuators, etc., which may receive instructions from one or more systems of vehicle 2, for example ECU 10. Based on these instructions, vehicle 2 may be controlled by an operator, ECU 10 in combination with system control 32, or both simultaneously (e.g., system controller 32 providing steering and braking assistance in a panic stop situation to prevent vehicle 2 from entering a no-entry route).

Display 25 may be configured to display information provided by ECU 10 to a driver of vehicle 2. FIG. 2 shows an exemplary display 25 providing information that may be of interest to a driver of vehicle 2. As shown at FIG. 2, a no-entry indicator is among the information currently displayed to a driver on display 25 to make the driver aware that this route should not be followed from the current position.

Display 25 may be any suitable device for providing visible and/or audible information to a driver of vehicle 2. For example, display 25 may include a heads up display (e.g., on a windshield in front of a driver), a monitor, an in-dash display, etc.

Based on the presence of a prohibited entry indicator, a determined and/or anticipated path of vehicle 2, and feature information provided to ECU 10, ECU 10 is configured to perform various operations for alerting (e.g., via display 25) the driver of a no-entry situation on a next link and/or preventing vehicle 2 from entering such a no-entry situation.

For purposes of explaining embodiments of the present disclosure an example using one or more no-entry signs 50 positioned around certain next link exits 90, 91 from a roundabout (i.e., a traffic circle) will be described. One of skill in the art will understand, however, that this is merely exemplary and not intended to be limiting.

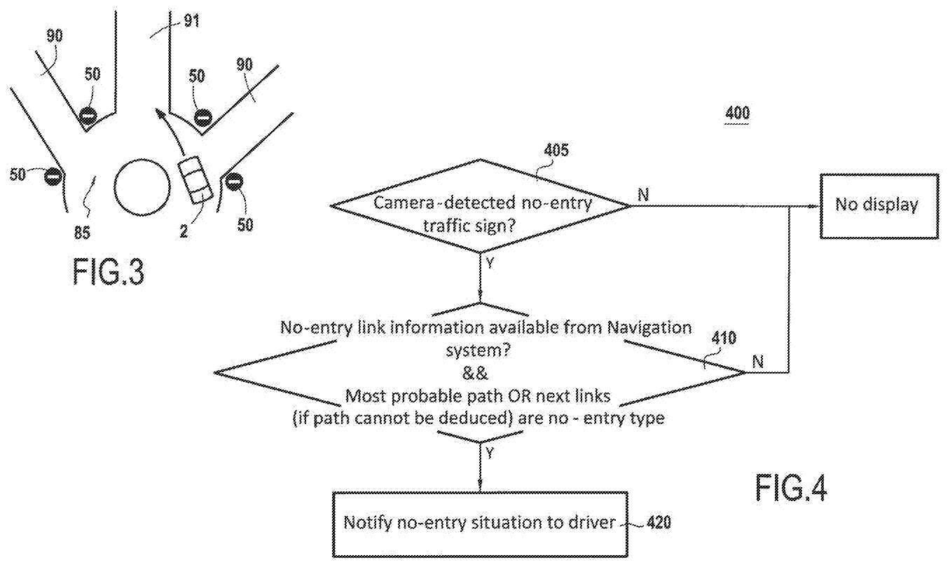

FIG. 4 is a flowchart highlighting an exemplary method for carrying out embodiments of the present disclosure, while FIG. 3 is a schematic representation of a vehicle 2 travelling around a current link traffic circle 85 with a number of next links (e.g., exits) 90, 91 positioned there around.

As vehicle 2 travels along current link segment 85 image obtaining means 15 may detect various regulation indicators, among them, for example, no-entry signs 50 indicating no-entry on next link 90 from current link traffic circle 85 (step 405). When a newly identified regulation indicator 50 has been detected, for example, a no-entry indicator 50, ECU 10 and/or image obtaining means 15 may determine whether the regulation indicator 50 is a no-entry sign or a direction of travel indicator indicating that exit from the current link 85 should not be undertaken on the indicated next link 90 (step 405). If the detected regulation indicator is not such an indicator, ECU 10 disregards the regulation indicator 50 for purposes of the present disclosure (step 405: no) and no display related to the present disclosure is made on display 25. One of skill will understand that other actions may be undertaken in the context of other desirable operations with regard to a regulation indicator 50 not processed under embodiments of the present disclosure.

When a regulation indicator 50 indicating no-entry or a direction of travel indicator prohibiting entry from current link 85 (e.g., a one-way sign) is detected by image obtaining means (step 405: yes), ECU 10 may check whether feature information associated with next links 90, 91 in proximity to the location of vehicle 2 include indications of no-entry and/or directional indicators prohibiting entry from current link 85 (step 410). If no such feature information is available and provided to ECU 10 (step 410: no), then no action is taken within the context of the present disclosure.

If the feature information associated with next links 90, 91 indicates presence of no-entry indicators and/or directional indicators prohibiting entry from current link 85, then a probable next link of the vehicle 2 is obtained, for example, from GPS 17 and/or ECU 10. As noted above, because a destination may be set in GPS 17 and a path selected by an operator of vehicle 2, GPS 17 may provide a probable next link on which vehicle 2 will travel. Alternatively, where a path has not been selected in GPS 17, a probable next link may be determined based on, for example, road class (e.g., vehicle travelling on non-toll road, continue travelling on non-toll roads, travelling direction (e.g., vehicle travelling north, continue travelling north), etc.

Once the probable next link is determined, features from the map information associated with the probable next link 90, 91 can be checked to determine whether the probable next link is a no-entry or prohibited direction route from current link 85. If the probable next link 90, 91 is not a no-entry or prohibited direction, then no action is taken within the context of the present disclosure (step 410: no).

If the feature information indicates that probable next link 90, 91 is a no-entry or prohibited direction (step 410: yes), then the display 25 is caused to indicate the no-entry sign to the operator of vehicle 2 (step 420). In addition, or alternatively, an audible or other sensory signal may be provided to the operator of vehicle 2.

According to some embodiments, ECU 10 may be configured to prevent vehicle 2 from entering a prohibited/no-entry next link 90, 91 by, for example, sending commands to vehicle controllers 32, thereby causing braking, steering, etc. of the vehicle to prevent passage to the prohibited entry next link.

As noted, one of skill will recognize that the example described above is not intended to be limiting. Further, a conditional indicator may be added to certain no-entry/one-way indicators, for example, an indicator showing effective days of the week and effective times, e.g., 5:00-9:00 on school days. Any such configuration is intended to fall within the scope of the present disclosure.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Where any standards of national, international, or other standards body are referenced (e.g., ISO, etc.), such references are intended to refer to the standard as defined by the national or international standards body as of the priority date of the present specification. Any subsequent substantive changes to such standards are not intended to modify the scope and/or definitions of the present disclosure and/or claims.

Although the present disclosure herein has been described with reference to particular embodiments, it is to be understood that these embodiments are merely illustrative of the principles and applications of the present disclosure.

It is intended that the specification and examples be considered as to exemplary only, with a true scope of the disclosure being indicated by the following claims.

1. A driver assistance system for a vehicle, comprising:
optical recognition means configured to obtain data regarding a regulation indicator in proximity to the vehicle;
location providing means configured to provide location information indicating a location of the vehicle relative to one or more next links in proximity to the location and to provide feature information related to the one or more next links; and
processing means configured to:
determine whether the data comprises at least one prohibited entry indication;
determine a probable next link of the vehicle based on a determined path and/or an anticipated path of the vehicle; and
cause display of no-entry information to an operator of the vehicle based on the determination of the at least one prohibited entry indication, the probable next link, and the feature information.

2. The driver assistance system according to claim 1, wherein the feature information comprises a directional indicator and/or a no-entry indicator for each next link within a predetermined distance of the location.

3. The driver assistance system according to claim 2, wherein when the data is determined to comprise at least one prohibited entry indication, the processor is configured to determine whether the feature information includes a corresponding no-entry link and, if the feature information includes a corresponding no-entry link, determine if the no-entry link corresponds to the probable next link for determining whether to cause display of no-entry information to the operator.

4. The driver assistance system according to claim 1, wherein the determined path and/or anticipated path is provided based on a preprogrammed destination in the location providing means.

5. The driver assistance system according to claim 1, wherein the processing means is further configured to control the vehicle to prevent the vehicle from exiting onto a no-entry next link.

6. A vehicle comprising the driver assistance system according to claim 1.

7. A method for assisting an operator of a vehicle, comprising:
obtaining data regarding a regulation indicator in proximity to the vehicle;
determining, by a processor, whether the data comprises at least one prohibited entry indication;
obtaining location information indicating a location of the vehicle relative to one or more next links in proximity to the location;
receiving feature information related to the one or more next links;
determining, by a processor, a probable next link of the vehicle based on a determined path and/or an anticipated path of the vehicle; and
causing display of no-entry information to an operator of the vehicle based on the determination of the at least one prohibited entry indication, the probable next link, and the feature information.

8. The method according to claim 7, wherein the feature information comprises a directional indicator and/or a no-entry indicator for each next link within a predetermined distance of the location.

9. The method according to claim 8, wherein when the data is determined to comprise at least one prohibited entry indication, a determination as to whether the feature information includes a corresponding no-entry link is performed and, if the feature information includes a corresponding no-entry link, determine if the no-entry link corresponds to the probable next link for determining whether to cause display of no-entry information to the operator.

10. The method according to claim 7, wherein the determined path and/or anticipated path is provided based on a preprogrammed destination in the location providing means.

11. The method according to claim 7, wherein the processing means is further configured to control the vehicle to prevent the vehicle from exiting onto a prohibited next link.
